(19) United States
(12) Patent Application Publication
(10) Pub. No.: US 2015/0242075 A1
(43) Pub. Date: Aug. 27, 2015

(54) METHOD FOR PROVIDING DOCUMENT DATA AND DOCUMENT DATA SERVER

(71) Applicant: TOSHIBA TEC KABUSHIKI KAISHA, Tokyo (JP)

(72) Inventors: Hiroshi WATANABE, Yokohama Kanagawa (JP); Takahiro HAGIWARA, Chiba Chiba (JP); Shinji MAKISHIMA, Suntou Shizuoka (JP); Toshihiro IDA, Mishima Shizuoka (JP); Yusuke HAMADA, Mishima Shizuoka (JP); Akihiro MIZUTANI, Mishima Shizuoka (JP); Ken SAKUTA, Izunokuni Shizuoka (JP)

(21) Appl. No.: 14/626,786

(22) Filed: Feb. 19, 2015

(30) Foreign Application Priority Data
Feb. 21, 2014 (JP) 2014-032061

(51) Int. Cl. G06F 3/0483; G06K 15/02; H04L 29/06; G06F 17/30; G06F 3/0482; G06F 3/0484

(52) U.S. Cl. CPC G06F 3/0483; G06F 3/0482; G06F 3/04842; H04L 65/602; G06F 17/30011; G06K 15/1803

(57) ABSTRACT

A method for providing document data includes storing document data of a document having a plurality of pages and page management data associated with the document data, the page management data indicating page numbers of one or more pages that are replacement pages of the document or inserted pages of the document, displaying a user interface including a plurality of selectable items, wherein each corresponds to one or more pages and indicating whether the pages are replacement pages or inserted pages, receiving a user input selecting one of the selectable items, extracting data from the document data, with reference to the page management data, of the one or more of pages corresponding to the item selected through the user interface, and outputting the extracted data.

### CROSS-REFERENCE TO RELATED APPLICATION

This application is based upon and claims the benefit of priority from Japanese Patent Application No. 2014-032061, filed Feb. 21, 2014, the entire contents of which are incorporated herein by reference.

### FIELD

Embodiments described herein relate generally to a method for providing document data and a document data server.

### BACKGROUND

In the related art, a document data server (an information providing apparatus) provides document data to a user terminal used by a user. One type of the document data server has a function of receiving a printing instruction from the user terminal and transmitting document data corresponding to the printing instruction to a printer so that the document is printed. It would be desirable for document data corresponding to a certain page of the stored document that satisfies a predetermined condition be output, instead of the entire document.

### DESCRIPTION OF THE DRAWINGS

FIG. 1 is a block diagram of a document distribution system including a document distribution server according to an embodiment.

FIG. 2 is a block diagram of a document distribution server in the document distribution system according to an exemplary embodiment.

FIG. 3 illustrates an example of material information stored in the document distribution server.

FIG. 4 illustrates an example of conference information stored in the document distribution server.

FIG. 5 illustrates an example of a conference information input screen.

FIG. 6 illustrates an example of page management data.

FIGS. 7 and 8 each illustrate another example of the page management data according to the exemplary embodiment.

FIG. 9 illustrates an example of writing management data.

FIG. 10 illustrates another example of the writing management data.

FIG. 11 illustrates an example of material extraction screens according to an embodiment.

FIG. 12 is a flowchart illustrating an operation carried out by the document distribution server according to an embodiment.

FIG. 13 illustrates an example of a page number list.

FIGS. 14-16 each illustrate another example of the page number list.

FIG. 17 illustrates an example of a private writing extraction list.

FIG. 18 illustrates an example of a shared writing extraction list.

### DETAILED DESCRIPTION

One or more embodiments of the present invention provide a method for providing document data, through which data of a page satisfying a predetermined condition can be extracted, and a document data server that performs such a method.

In general, according to one embodiment, a method for providing document data includes storing document data of a document having a plurality of pages and page management data associated with the document data, the page management data indicating page numbers of one or more pages that are replacement pages of the document or inserted pages of the document, displaying a user interface including a plurality of selectable items, wherein each corresponds to one or more pages and indicating whether the pages are replacement pages or inserted pages, receiving a user input selecting one of the selectable items, extracting data from the document data, with reference to the page management data, of the one or more of pages corresponding to the item selected through the user interface, and outputting the extracted data.

Hereinafter, exemplary embodiments will be described with reference to the accompanying drawings.

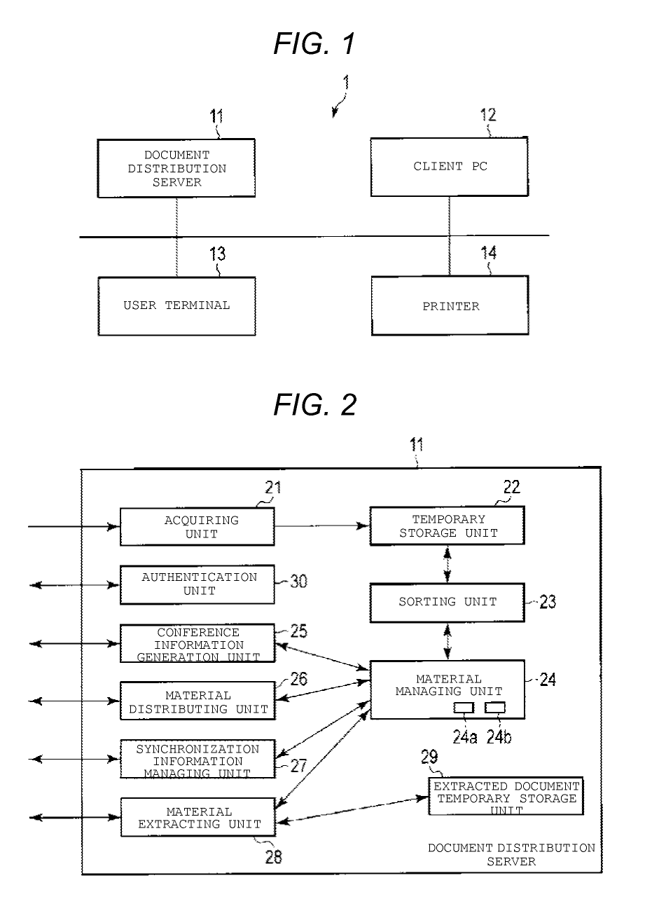

FIG. 1 is a block diagram of a document distribution system 1 including a document distribution server 11 according to an embodiment.

The document distribution system 1 provides document data to a user terminal 13. Specifically, the document distribution system 1 transmits the document data to the user terminal 13 or prints the document data using a printer 14, according to an instruction from the user terminal 13.

Here, the document distribution system 1 distributes document data relating to a conference to the user terminal 13 or prints the document data using the printer 14. Data distributed by the document distribution system 1 is not limited to specific data.

As illustrated in FIG. 1, the document distribution system 1 includes the document distribution server 11, a client PC 12, the user terminal 13, the printer 14, and the like.

The document distribution server 11 (information providing apparatus) stores document data to be provided to the user terminal 13. Further, the document distribution server 11 distributes the document data to the user terminal 13 or prints the document data using the printer 14. The document distribution server 11 will be described in detail below.

The client PC 12 is a terminal that controls the document distribution server 11 to store the document data to be used for a conference. The client PC 12 operates to store the document data to be distributed by the document distribution server 11 in the document distribution server 11. For example, a user generates document data using the client PC 12, and operates the client PC 12 to store the generated document data in the document distribution server 11. Further, the user may operate to store data that is generated through another PC or the like, in the document distribution server 11 through the client PC 12.

Further, the client PC 12 displays a conference information input screen. The user who operates the client PC 12 to save the document data inputs conference information through the conference information input screen. The conference information input screen and the conference information will be described below.

The client PC 12 includes a CPU, a RAM, a ROM, a nonvolatile memory, an operation unit, a display unit, and the like. The client PC 12 may be a personal computer or the like.

The user terminal 13 requests the document data from the document distribution server 11 according to a user's instruction. The user terminal 13 acquires the document data transmitted from the document distribution server 11 according to the request, and displays the document data to the user.

Further, the user terminal 13 requests the document distribution server 11 to perform printing of the document data according to a user's instruction.

The user terminal 13 displays a material extraction screen. The user of the user terminal 13 requests the user terminal 13 to acquire the document data or to print the document data through the material extraction screen. The material extraction screen will be described in detail below.

The user terminal 13 includes a CPU, a RAM, a ROM, a nonvolatile memory, a communication interface, an operation unit, a display unit, and the like. The user terminal 13 may be a tablet PC, a smart phone, a notebook PC, or the like.

The printer 14 prints the document data based on an instruction from the document distribution server 11. For example, the printer 14 receives a PRN file of the document data from the document distribution server 11, and prints an image corresponding to the document data based on the received PRN file.

The printer 14 includes a paper supply unit, a printing unit, and the like. The printer 14 may be an electrophotographic printer or an inkjet printer.

The document distribution system 1 may include plural user terminals 13.

Next, the document distribution server 11 will be described. FIG. 2 is a block diagram of the document distribution server 11. As illustrated in FIG. 2, the document distribution server 11 includes an acquiring unit 21, a temporary storage unit 22, a sorting unit 23, a material managing unit 24, a conference information generating unit 25, a material distributing unit 26, a synchronization information managing unit 27, a material extracting unit 28, an extracted document temporary storage unit 29, an authentication unit 30, and the like.

The acquiring unit 21 receives the document data from the client PC 12. The acquiring unit 21 operates to store the document data received from the client PC 12 in the temporary storage unit 22.

The temporary storage unit 22 stores the document data transmitted from the client PC 12.

Based on an instruction of the user who operates the client PC 12 to store the document data, the sorting unit 23 selects document data to be used as a conference material from the document data stored in the temporary storage unit 22, and stores the selected document data in the material managing unit 24. The user operates the client PC 12 to cause the document data to be used as the conference material to be selected from the document data stored in the temporary storage unit 22 and the selected document data to be stored in the material managing unit 24, by the sorting unit 23. Thus, the user may give an instruction to the sorting unit 23 through the client PC 12.

The material managing unit 24 stores a set of the document data, which is the conference material, material information relating to the document data, and conference information relating to the conference, in correlation with each other.

Further, the material managing unit 24 includes storage regions 24a and 24b. The storage region 24a stores page management data (page management data 24a) indicating page replacement or page insertion with respect to the document data. Further, the storage region 24b stores writing management data (writing management data 24b) indicating an image input on a page of the document data.

The page management data 24a, the writing management data 24b, the material information, and the conference information will be described below in detail.

The conference information generating unit 25 generates conference information based on an instruction of a user who operates the client PC 12 to generate the conference information.

The material distributing unit 26 transmits the document data set, which is the conference material, according to a request from the user terminal 13.

The synchronization information managing unit 27 manages the writing management data 24b indicating the content of the document data input by the user of the user terminal 13. The writing management data 24b will be described in detail below.

Further, the synchronization information managing unit 27 causes information input by the user of the user terminal 13 for sharing with another user to be shared with another user terminal 13. That is, when a certain user inputs information to document data, the synchronization information managing unit 27 also displays the input information on the user terminal 13 used by another user.

In addition, the synchronization information managing unit 27 generates and updates the writing management data 24b based on a user's operation to input information on a page.

The material extracting unit 28 receives a condition of a page to be extracted, from the user terminal 13. The material extracting unit 28 extracts document data (extracted document data) according to the condition received from the user terminal 13, from the material managing unit 24. The material extracting unit 28 stores the extraction document data in the extracted document temporary storage unit 29.

When the extracted document data is stored in the extracted document temporary storage unit 29, the material extracting unit 28 adds an input of the user to the extracted document data. If the input is added to the extracted document data, the material extracting unit 28 transmits the extracted document data to the user terminal 13, or prints the extracted document data using the printer 14. When the extracted document data is transmitted to the user terminal 13, the material extracting unit 28 converts the extracted document data into a PDF file, and transmits the PDF file to the user terminal 13, for example. Further, when the extracted document data is printed, the material extracting unit 28 converts the extracted document data into a PRN file, and transmits the PRN file to the printer 14.

The extracted document temporary storage unit 29 temporarily stores the extracted document data.

The authentication unit 30 performs an authentication process of the client PC 12, the user terminal 13, or the like. The authentication unit 30 may be achieved by another apparatus (sever) or the like.

The document distribution server 11 includes a CPU, a RAM, a ROM, a nonvolatile memory, a communication interface, an operation unit, a display unit, and the like. The document distribution server 11 may be configured with a PC or the like.

The acquiring unit 21, the conference information generating unit 25, the material distributing unit 26, the synchronization information managing unit 27, the material extracting unit 28, and the authentication unit 30 may be achieved by the CPU, the RAM, the communication interface, and the like of the document distribution server 11. For example, the CPU of the document distribution server 11 performs the functions of the acquiring unit 21, the conference information generating unit 25, the material distributing unit 26, the synchronization information managing unit 27, the material extracting unit 28, and the authentication unit 30 by executing a program on the RAM and by controlling the communication interface.

Further, the temporary storage unit 22, the material managing unit 24, and the extracted document temporary storage unit 29 are configured with the nonvolatile memory or the like.

The temporary storage unit 22 and the extracted document temporary storage unit 29 may be configured with the RAM.

In addition, the sorting unit 23 is achieved by the CPU, the RAM, and the like. For example, the CPU of the document distribution server 11 performs the function of the sorting unit 23 by executing a program stored in the RAM.

Next, the material information will be described.

The material information is information relating to the document data.

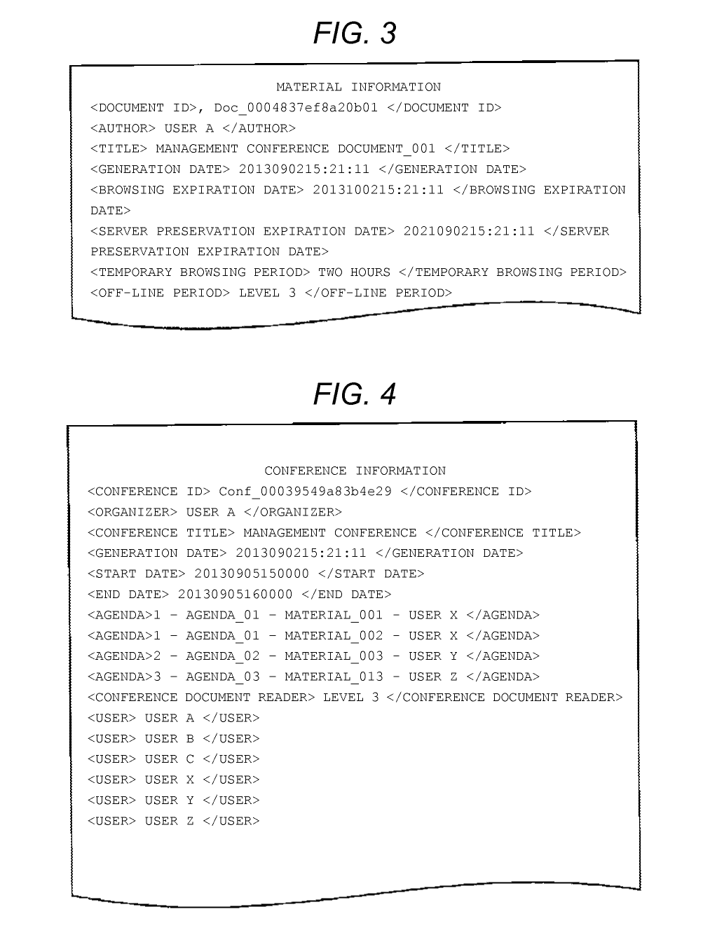

FIG. 3 illustrates an example of the material information.

As illustrated in FIG. 3, the material information includes a document ID, an author, a title, a generation date, a browsing expiration date, a server preservation expiration date, a temporary browsing period, an off-line period, and the like.

The document ID represents an ID that specifies the document data. Here, the document ID includes alphanumeric characters.

The author represents a user who input the document data. The author may delete or modify the document, for example.

The title represents a title of the document data.

The generation date represents the date and time when the author generates the document data in the material managing unit 24.

The browsing expiration date represents a date and time until when the document data is allowed to be browsed from the user terminal 13.

The server preservation expiration date represents a date and time until when the document distribution server 11 preserves the document data.

The temporary browsing period represents a period during which the document data is allowed to be continuously browsed from the user terminal 13.

The off-line period represents a period during which the document data is stored in the user terminal 13 as a cache to be browsed off-line.

The material information is not limited to a specific configuration.

Next, the conference information will be described. The conference information is information relating to a conference. FIG. 4 illustrates an example of the conference information. As illustrated in FIG. 4, the conference information includes a conference ID, an organizer, a conference title, a generation date, a start date, an end date, an agenda, and a conference document reader.

The conference ID represents an ID that specifies a conference that is scheduled to be held. Here, the conference ID includes alphanumeric characters.

The organizer represents a person who organized the conference.

The conference title represents a title of the conference.

The generation date represents the date and time when the conference information was generated.

The start date represents a scheduled state date and time the conference.

The end date represents a scheduled end date and time of the conference.

The agenda represents a topic of the conference.

The conference document reader represents a person who is authorized to read the conference document (document data).

Here, the conference information is not limited to a specific configuration.

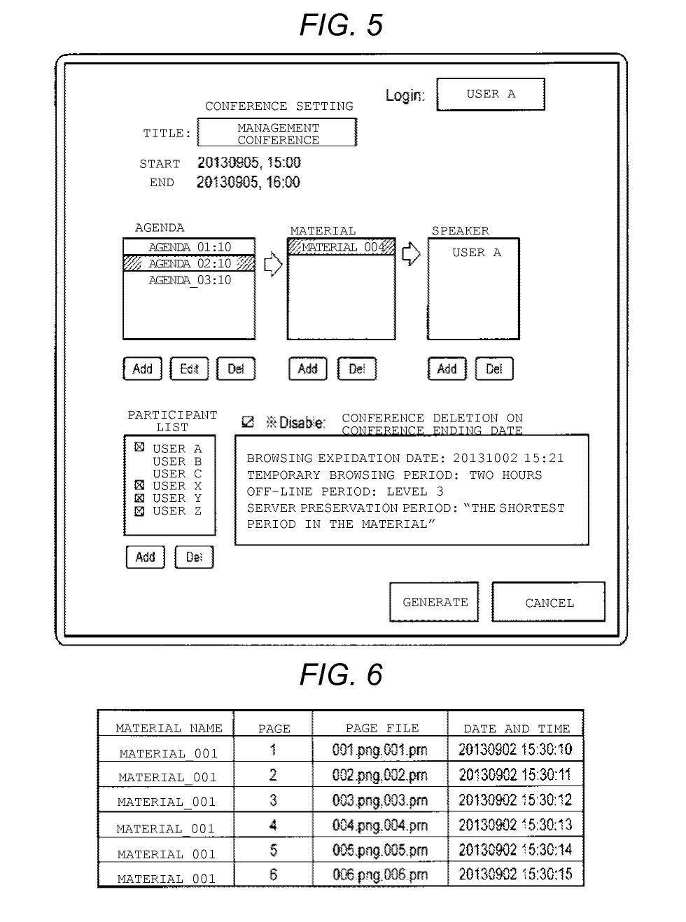

Next, the conference information setting screen will be described. FIG. 5 illustrates an example of the conference information setting screen. The conference information setting screen is a screen for generating the conference information.

The conference information setting screen is displayed in the display unit of the client PC 12.

For example, a user who wants to organize a conference operates the client PC 12 to display the conference information setting screen. The conference information setting screen may be generated by the client PC 12, or may be generated by the conference information generating unit 25.

As illustrated in FIG. 5, the conference information setting screen includes input sections where various kinds of information relating to the conference can be input.

For example, the conference information setting screen includes input sections in which a conference title, a starting time, an ending time, an agenda, a participant list, and the like can be input.

Further, the conference information setting screen includes input sections in which a browsing period, a temporary browsing period, an off-line period, a server preservation period, and the like of the material information can be input.

The client PC 12 transmits data input in the respective input sections to the document distribution server 11.

The conference information generating unit 25 of the document distribution server 11 generates the conference information based on the received data. Further, the conference information generating unit 25 may generate the material information based on the received data.

The conference information generating unit 25 stores the generated conference information and material information in the material managing unit 24.

Next, the page management data 24a will be described. The page management data 24a is data indicating page replacement and page insertion situation in the material (document data). One or both of the page replacement and insertion may be performed. The page management data 24a is set for each document data.

FIG. 6 illustrates an example of the page management data 24a. As illustrated in FIG. 6, the page management data 24a stores a material name, a page, a page file, a date and time, and the like in correlation.

The material name represents material (document data) for which the page management data 24a is set.

The page represents a page number.

The page file represents a file name of the page indicated by the page number.

The date and time represent the date and time when the page indicated by the page number has been replaced or inserted.

The material name of the page management data 24a illustrated in FIG. 6 is “material_{—}001.” Accordingly, the page management data 24a is set for “material_{—}001.”

Further, in the example illustrated in FIG. 6, the page management data 24a includes “001.png, 001.prn” as a page file corresponding to page “1.” That is, the page management data 24a indicates that an image file of page “1” is “001.png,” and that a print file of page “1” is “001.prn.”

The page management data 24a includes “20130902 15:30:10” as a date and time corresponding to page “1.” That is, the page management data 24a indicates that page “1” has been replaced or inserted at 15:30:10 on Sep. 2, 2013.

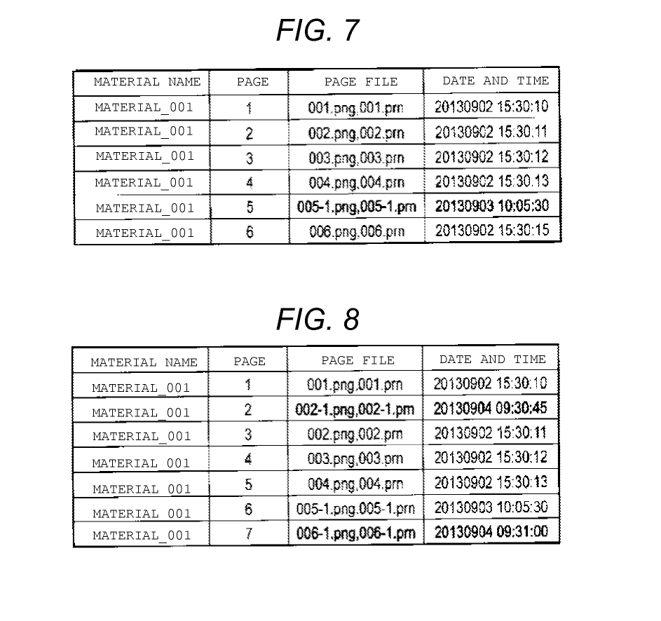

FIG. 7 illustrates another example of the page management data 24a, which is different from the page management data 24a illustrated in FIG. 6. The page management data 24a illustrated in FIG. 7 corresponds to a state in which the page file in page “5” of the page management data 24a illustrated in FIG. 6 is replaced with another page file.

As illustrated in FIG. 7, the page management data 24a includes “005-1.png, 005-1.prn” as a page file corresponding to page “5.” That is, the page management data 24a indicates that the page file corresponding to page “5” is replaced with “005-1.png, 005-1.prn.”

Further, the page management data 24a includes “20130903 10:05:30” as a date and time corresponding to page “5.” That is, the page management data 24a indicates that the page file corresponding to page “5” has been replaced at 10:05:30 on Sep. 3, 2013 with “005-1.png, 005-1.prn.”

FIG. 8 illustrates another example of the page management data 24a, which is different from the page management data 24a illustrated in FIGS. 6 and 7. The page management data 24a illustrated in FIG. 8 corresponds to a state in which a new page is inserted between page “1” and page “2” of the page management data 24a illustrated in FIG. 7 and a page file of page “6” of the page management data 24a illustrated in FIG. 7 is replaced with another page file.

As illustrated in FIG. 8, the page management data 24a includes “002-1.png, 002-1.prn” as a page file corresponding to page “2.” Further, the page management data 24a includes “20130904 09:30:45” as a date and time corresponding to page “2.” Accordingly, the page management data 24a indicates that page “2” has been inserted at 09:30:45 on Sep. 4, 2013 and the page file of page “2” is “002-1.png, 002-1.prn.”

Further, as page “2” has been inserted, the previous page “2” to page “6” are shifted to page “3” to page “7.”

In addition, the page management data 24a includes “006-1.png, 006-1.prn” as a page file corresponding to page “7.” The page management data 24a includes “20130904 09:31:00” as a date and time corresponding to page “7.” Accordingly, the page management data 24a indicates that the page file corresponding to page “7” has been replaced with “006-1.png, 006-1.prn” at 09:31:00 on Sep. 4, 2013.

The configuration of the page management data 24a is not limited to a specific configuration.

Next, the writing management data 24b will be described. The writing management data 24b represents a state of an image input to each page of the material (document data). The writing management data 24b is set with respect to each material (document data).

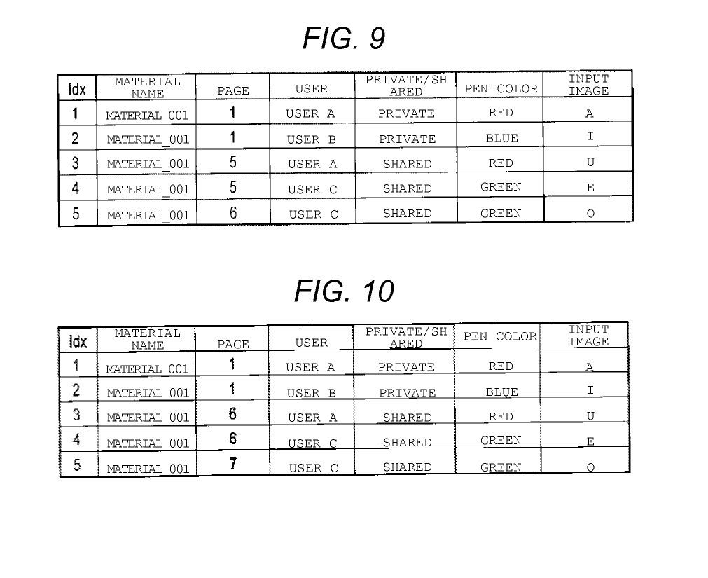

FIG. 9 illustrates an example of the writing management data 24b.

As illustrated in FIG. 9, the writing management data 24b includes Idx, a material name, a page, a user, private/shared, pen color, writing content, and the like, in correlation.

The Idx represents a number for identifying the input image.

The material name represents the corresponding material (document data) for which the writing management data 24b is set.

The page represents a page number of a page where the image input has been performed.

The user represents a user who performs the image input on the page.

The private/shared represents whether the user performs the image input for private purpose or for sharing with other users. The “private” represents that the user performs the image input for private purpose. Further, the “shared” represents that the user performs the image input for sharing with other users.

The pen color represents a color of the image input by the user.

The writing content represents a text as the image input by the user.

The material name of the writing management data 24b illustrated in FIG. 9 is “material_{—}001.” Accordingly, the writing management data 24b is set for “material_{—}001.”

In the example illustrated in FIG. 9, the writing management data 24b represents that users A and B have performed the image inputs on page “1.” For example, the writing management data 24b represents that the user A writes “A” on page “1” using a “red” color for “private” purpose.

FIG. 10 illustrates another example of the writing management data 24b, which is different from the writing management data 24b illustrated in FIG. 9. The writing management data 24b illustrated in FIG. 10 corresponds to a state in which page “2” is inserted in the writing management data 24b illustrated in FIG. 9.

As illustrated in FIG. 10, on page “2” and thereafter, the page number is incremented by 1.

The writing management data 24b may include a writing date and time. The configuration of the writing management data 24b is not limited to a specific configuration.

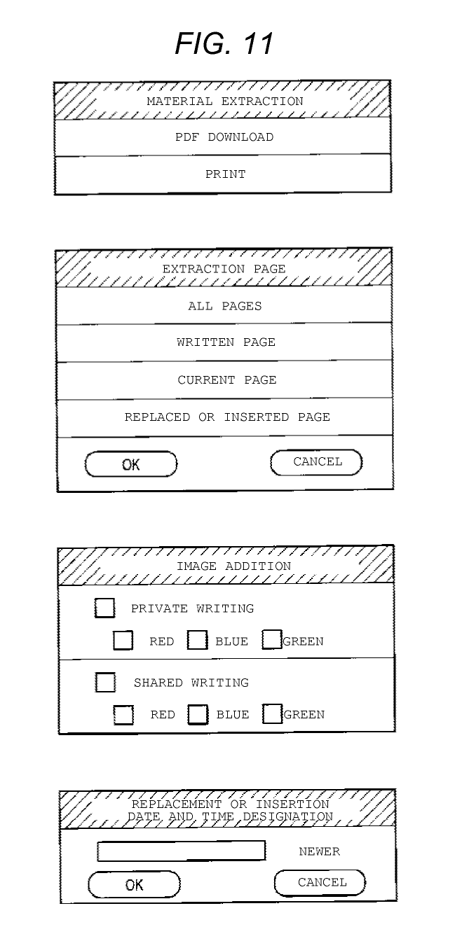

Next, the material extraction screen will be described. FIG. 11 illustrates an example of the material extraction screen. The material extraction screen is a screen for a user of the user terminal 13 to extract a material (document data) from the document distribution server 11. The material extraction screen is displayed in the display unit of the user terminal 13.

For example, the user of the user terminal 13 touches an icon or the like of the user terminal 13 to display the material extraction screen.

As illustrated in FIG. 11, the material extraction screen includes a material extraction section, an extraction page section, an image addition section, a date and time designation section of replacement or insertion, and the like.

The material extraction section is used to designate an output format of the material to be extracted. Here, through the material extraction section, one of “PDF download” or “print” is selected If a user selects “PDF download,” the material extracting unit 28 transmits the document data extracted from the material managing unit 24 to the user terminal 13 in a PDF format. Further, if the user selects “print,” the material extracting unit 28 transmits the document data extracted from the material managing unit 24 to the printer 14 in a PRN format.

The extraction page section is used to designate a condition of a page to be extracted (extraction condition). Through the extraction page section, one of “all pages,” “written page,” “current page,” and “replaced/inserted page” is selected.

If the user selects “all pages” in the extraction page section, the material extracting unit 28 extracts all pages managed by the page management data 24a from the material managing unit 24.

If the user selects “written page” in the extraction page section, the material extracting unit 28 extracts pages in which images were input based on the writing management data 24b from the material managing unit 24.

If the user selects “current page” in the extraction page section, the material extracting unit 28 extracts a currently displayed page from the material managing unit 24.

If the user selects “replaced/inserted page” in the extraction page section, the material extracting unit 28 extracts replaced or inserted pages based on the page management data 24a from the material managing unit 24.

The image addition section is used to designate a condition for images added to a page to be extracted (additional image condition). The image addition section includes a private writing check box and a shared writing check box. Further, with respect to each of the private writing check box and the shared writing check box, a red check box, a blue check box, and a green check box are prepared in a lower layer thereof.

When the user does not check the check boxes of the image addition section, the material extracting unit 28 outputs the extracted material without the added images.

When the user checks the private writing check box, the user terminal 13 determines “private writing” as the additional image condition. Further, when the user checks a check box in the lower layer of the private writing check box, the user terminal 13 determines a color corresponding to the check box as the additional image condition.

For example, when the user checks the private writing check box and the red check box in the lower layer of the private writing check box, the user terminal 13 determines “red” of “private writing” as the additional image condition.

If the additional image condition is received, the material extracting unit 28 adds the images added with the red color during the private writing of the user, to the page.

Similarly, when the user checks the shared writing check box, the user terminal 13 determines “shared writing” as the additional image condition. Further, when the user checks a check box in the lower layer of the shared writing check box, the user terminal determines a color corresponding to the check box as the additional image condition.

When there is no check in the check boxes in the lower layer, the material extracting unit 28 may determine that all colors are designated and may add images of all the colors to the page, or may determine that color designation is not performed and may add no image to the page.

The replacement or insertion date and time designation section is used to designate, when the user selects “replaced/inserted page” in the extraction page section, a time when the replaced or inserted page is to be extracted (date and time condition). In the replacement or insertion date and time designation section, extraction of the replaced or inserted page on a predetermined date and time and thereafter is designated as the date and time condition.

The date and time condition may be a predetermined date and time designated to extract the replaced or inserted page. Further, the date and time condition may a predetermined period within which the replaced or inserted page is extracted.

Next, an example of a writing operation from the user terminal 13 to the page will be described. First, the user inputs selecting one of “private” and “shared” to the user terminal 13. Further, the user inputs input information such as color and thickness of the image to be input.

The user performs an input operation on the displayed page using a finger, a mouse, or the like.

The user terminal 13 transmits private/shared, pen information, writing position information (stroke information), and the like to the document distribution server 11.

The synchronization information managing unit 27 of the document distribution server 11 receives the information. The synchronization information managing unit 27 analyzes the information and adds data in the writing management data 24b stored in the material managing unit 24.

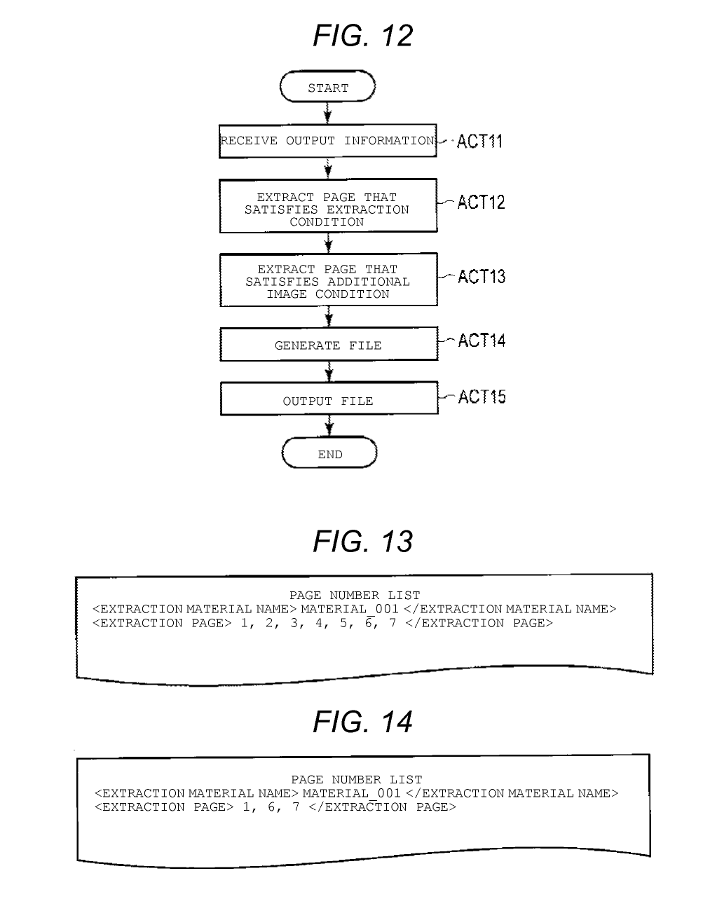

Next, an operation in which the document distribution server 11 outputs the material (document data) will be described. FIG. 12 is a flowchart illustrating the operation in which the document distribution server 11 outputs the material.

Here, it is assumed that the user inputs various kinds of information (output information) such as an extraction condition, an additional image condition, or a date and time condition on the material extraction screen displayed on the user terminal 13. Further, it is assumed that the user terminal 13 transmits the output information input through the material extraction screen by the user to the document distribution server 11.

First, the document distribution server 11 receives the output information from the user terminal 13 (ACT 11).

If the document distribution server 11 receives the output information, the material extracting unit 28 of the document distribution server 11 extracts a page that satisfies the extraction condition included in the output information, and generates a list of the extracted page (page number list) (ACT 12). That is, the page number list includes the page number of each page of the extracted document data.

For example, when the output information includes “all pages” as the extraction condition, the material extracting unit 28 extracts all pages based on the page management data 24a. That is, the material extracting unit 28 extracts all pages of the page management data 24a as the pages that satisfy the extraction condition.

Further, when the output information includes “written page” as the extraction condition, the material extracting unit 28 extracts the pages on which images are input based on the writing management data 24b. That is, the material extracting unit 28 extracts the pages stored in the writing management data 24b as the pages that satisfy the extraction condition.

Further, when the output information includes “current page” as the extraction condition, the material extracting unit 28 extracts the page displayed on the user terminal 13.

Further, when the output information includes “replaced/inserted page” as the extraction condition, the material extracting unit 28 extracts the pages of the document data based on the page management data 24a and the date and time stored in the output information. That is, the material extracting unit 28 extracts the replaced or inserted pages after the date and time indicated by the date and time condition, as the pages that satisfy the extraction condition, from the page management data 24a.

In ACT 12, the material extracting unit 28 generates extraction document data including pages identified by page numbers included in the page number list. If the extraction document data is generated, the material extracting unit 28 stores the generated extraction document data in the extracted document temporary storage unit 29.

If the page number list is generated, the material extracting unit 28 extracts pages that satisfy the additional image condition included in the output information from the pages identified by the page number list based on the writing management data 24b, and generates a list of the extracted pages (private writing extraction list and shared writing extraction list) (ACT 13).

For example, when the additional image condition included in the output information designates “red” of “private writing” and does not designate “shared writing,” the material extracting unit 28 retrieves a page in which the “private/shared” is “private” and the pen color is “red” from the writing management data 24b. If the page in which the “private/shared” is “private” and the pen color is “red” is retrieved from the writing management data 24b, the material extracting unit 28 extracts an overlapped page of the page stored in the page number list and the retrieved page, and generates a private writing extraction list for storing the extracted page number. Further, the material extracting unit 28 generates a blank shared writing extraction list.

Further, when the additional image condition stored in the output information designates “red” of “shared writing” and does not designate “private writing,” the material extracting unit 28 retrieves a page in which “private or shared” is “shared” and the pen color is “red” from the writing management data 24b. If the page in which the “private/shared” is “shared” and the pen color is “red” is retrieved from the writing management data 24b, the material extracting unit 28 extracts an overlapped page of the page stored in the page number list and the retrieved page, and generates a shared writing extraction list for storing the extracted page number. Further, the material extracting unit 28 generates a blank private writing extraction list.

If the private writing extraction list and the shared writing extraction list are generated, the material extracting unit 28 generates an extraction file including the extraction document data based on the page number list and the writing extraction list (ACT 14). When the user selects “PDF download,” the material extracting unit 28 generates a PDF file as the extraction file. Further, when the user selects “print,” the material extracting unit 28 generates a PRN file as the extraction file.

In ACT 14, the material extracting unit 28 adds the input images on the pages designated by the private writing extraction list and the shared writing extraction list to image data of the pages designated by the page number list. For example, when the file is generated in the PDF format, the material extracting unit 28 rasterizes the writing content, and adds the rasterization result to the PNG file of the page. Further, when the file is generated in the PRN format, the material extracting unit 28 converts the input images into a PDL printing format, and adds the result to the PRN file of the page.

For example, when the additional image condition designates “red” of “private writing,” the material extracting unit 28 acquires the input image corresponding to “private” and “red” of the page designated by the private writing extraction list from the writing management data. If the input image is acquired, the material extracting unit 28 adds information indicated by the acquired input image to a corresponding page of the extraction document data.

Further, when the additional image condition designates “red” of “shared writing,” the material extracting unit 28 acquires the input image corresponding to “shared” and “red” of the page designated by the shared writing extraction list from the writing management data. If the input image is acquired, the material extracting unit 28 adds information indicated by the acquired input image to a corresponding page of the extraction document data.

If the extraction file is generated, the material extracting unit 28 outputs the generated extraction file (ACT 15). That is, when the user selects “PDF download,” the material extracting unit 28 outputs the PDF file as the extraction file to the user terminal 13. Further, when the user selects “print,” the material extracting unit 28 outputs the PRN file as the extraction file to the printer 14.

If the extraction file is output, the material extracting unit 28 terminates the operation.

When the material extracting unit 28 outputs the PDF file to the user terminal 13, the user terminal 13 may store the output PDF file in a nonvolatile memory or the like.

Further, when the material extracting unit 28 outputs the PRN file to the printer 14, the printer 14 prints an image based on the output PRN file.

Next, examples of the page number list generated by the material extracting unit 28 in ACT 12 will be described.

Examples of the page number list illustrated in the following description represent cases in which the page management data 24a is as illustrated in FIG. 8 and the writing management data 24b is as illustrated in FIG. 10.

FIG. 13 illustrates an example of the page number list. The page number list illustrated in FIG. 13 corresponds to an example in which the user selects “all pages” as the extraction condition. As illustrated in FIG. 13, the page number list includes page numbers “1, 2, 3, 4, 5, 6, 7” of all pages included in the page management data 24a.

FIG. 14 illustrates another example of the page number list.

The page number list illustrated in FIG. 14 corresponds to an example in which the user selects “written page” as the extraction condition. As illustrated in FIG. 14, the page number list includes page numbers “1, 6, 7” of pages included in the writing management data 24b.

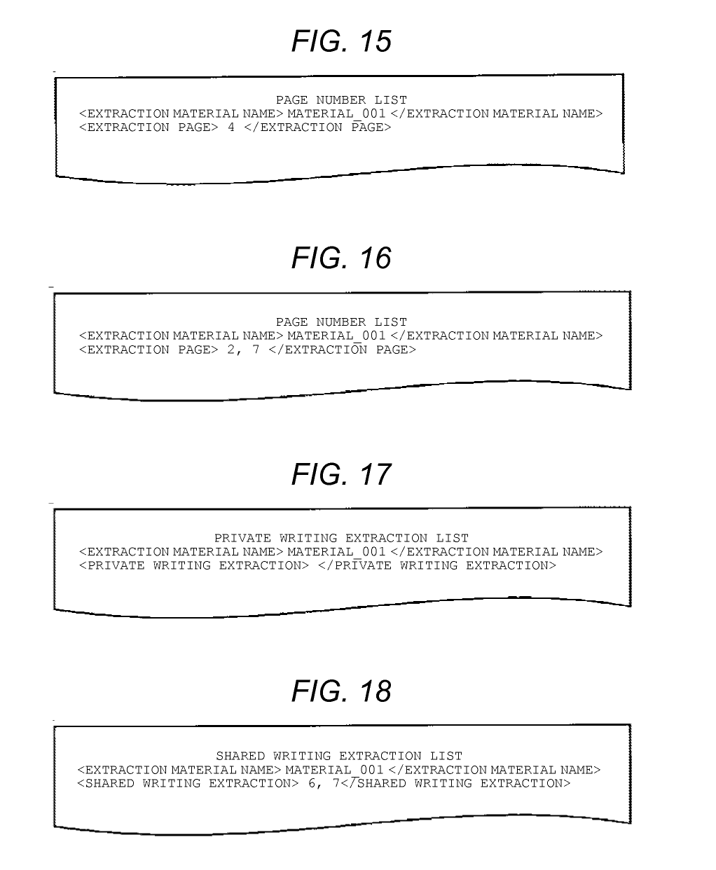

FIG. 15 illustrates another example of the page number list. The page number list illustrated in FIG. 15 is an example in which the user selects “current page” as the extraction condition. Here, the user terminal 13 displays page “4.” As illustrated in FIG. 15, the page number list includes page number “4” of a page that is currently displayed.

FIG. 16 illustrates still another example of the page number list. The page number list illustrated in FIG. 16 corresponds to an example in which the user selects “replaced/inserted page” as the extraction condition, and designates “20130903 17:00:00” as the date and time condition. As illustrated in FIG. 16, the page number list includes page numbers “2, 7” of which the date and time is “20110903 17:00:00” and thereafter in the page management data.

Next, an example of the private writing extraction list and the shared writing extraction list generated by the material extracting unit 28 in ACT 13 will be described.

In the following example, it is assumed that the user selects “written page” as the extraction condition. Accordingly, it is assumed that the material extracting unit 28 generates the page number list illustrated in FIG. 14.

Further, it is assumed that the user designates “red,” “blue,” and “green” of “shared writing” as the additional condition and does not designate “private writing.”

FIG. 17 illustrates an example of the private writing extraction list. Since the additional image condition does not designate “private writing” as illustrated in FIG. 17, the private writing extraction list is black.

FIG. 18 illustrates an example of the shared writing extraction list. As illustrated in FIG. 18, the shared writing extraction list includes page numbers “6, 7” overlapped between page numbers “1, 6, 7” designated by the page number list, and page numbers “6, 7” corresponding to “shared” and “red,” “private” and “blue,” or “private” and “green” in the writing management data 24b.

The material extracting unit 28 may receive designation of the time when the image input is performed as the page extraction condition. For example, the material extracting unit 28 may extract pages written on a certain date and time and thereafter.

Further, the material extracting unit 28 may receive “page written by specific user” as the page extraction condition. In this case, the material extracting unit 28 may extract the page written by the specific user.

Furthermore, the material extracting unit 28 may receive additional image input by a specific user as the additional image condition.

In the exemplary embodiment, a case where the functions for achieving the invention are stored in the apparatus in advance is described, but the invention is not limited thereto, and the same functions may be downloaded to the apparatus from a network, or the same functions may be stored in a recording medium to be installed to the apparatus. The recording medium may be any type of recording medium that is capable of storing a program and is readable by the apparatus, such as a CD-ROM. Further, the functions acquired by such installation or downloading in advance may be achieved in cooperation with an operating system (OS) or the like in the apparatus.

The document distribution server having the above-described configuration may extract a page on which an image has been input or a replaced/inserted page according to a request from a user. Accordingly, the document distribution server may output an extracted page according to conditions.

While certain embodiments have been described, these embodiments have been presented by way of example only, and are not intended to limit the scope of the inventions. Indeed, the novel embodiments described herein may be embodied in various other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for providing document data, comprising:
storing document data of a document having a plurality of pages and page management data associated with the document data, the page management data indicating page numbers of one or more pages that are replacement pages of the document or inserted pages of the document;
displaying a user interface including a plurality of selectable items, each corresponding to one or more pages and indicating whether the pages are replacement pages or inserted pages;
receiving a user input selecting one of the selectable items;
extracting data from the document data, with reference to the page management data, of the one or more of pages corresponding to the item selected through the user interface; and
outputting the extracted data.

2. The method according to claim 1, further comprising:
displaying a second interface for setting a condition to extract the data based on a time when each of the replacement pages or the inserted pages has been created; and
receiving a user input designating the condition, wherein the data is extracted based on the condition.

3. The method according to claim 1, further comprising:
generating an extracting page list indicating a page number of the page to be extracted based on the user input, wherein
the data is extracted based on the extracting page list.

4. The method according to claim 1, wherein
the extracted data is output to a printing device, such that the one or more pages corresponding to the extracted data are printed.

5. The method according to claim 1, wherein
the document data is output to the user device, such that the page of the extracted data is displayed thereon.

6. The method according to claim 1, wherein
the page management data includes a page identification code and an updated time with respect to each page of the document.

7. The method according to claim 1, further comprising:
storing image addition management data associated with the document data, the image addition management data indicating page numbers of one or more modified pages in which a new image has been added, wherein
the selectable items include an item corresponding to one or more pages and indicating that the pages are modified pages.

8. A method for providing document data comprising:
storing document data of a document having a plurality of pages and image addition management data associated with the document data, the image addition management data indicating page numbers of one or more modified pages in which a new image has been added;
displaying a user interface including a plurality of selectable items, including a first item corresponding to one or more pages and indicating that the pages are modified pages;
receiving a user input selecting one of the selectable items;
extracting data from the document data, with reference to the image addition management data, of the one or more of pages corresponding to the first item, when the first item is selected through the user interface; and
outputting the extracted data.

9. The method according to claim 8, further comprising:
displaying a second interface for setting a first condition to extract the data based on a user who added the new image; and
receiving a user input designating the first condition, wherein the data is extracted based on the first condition.

10. The method according to claim 9, further comprising:
displaying a third interface for setting a second condition to extract the data based on a color of the added image; and
receiving a user input designating the second condition, wherein the data is extracted further based on the second condition.

11. The method according to claim 8, further comprising:
generating an extracting page list indicating a page number of the page to be extracted based on the user input, wherein the data is extracted based on the extracting page list.

12. The method according to claim 8, wherein
the document data is output to a printing device, such that the pages corresponding to the extracted data are printed.

13. The method according to claim 8, wherein
the document data is output to the user device, such that the page of the extracted data is displayed thereon.

14. The method according to claim 8, wherein
the page management data includes a page identification code and an updated time with respect to each page of the document.

15. A document data server comprising:
a storage unit storing document data of a document having a plurality of pages and page management data associated with the document data, the page management data indicating page numbers of one or more pages that are replacement pages of the document or inserted pages of the document; and
a control unit configured to
cause a display device to display a user interface including a plurality of selectable items, each corresponding to one or more pages and indicating whether the pages are replacement pages or inserted pages,
receive a user input selecting one of the selectable items,
extract data from the document data, with reference to the page management data, of the one or more of pages corresponding to the item selected through the user interface, and
cause the extracted data to be output.

16. The document data server according to claim 15, wherein
the control unit is further configured to generate an extracting page list indicating a page number of the page to be extracted based on the user input, and
the control unit extracts the data based on the extracting page list.

17. The document data server according to claim 15, wherein
the document data is output to a printing device, such that the pages corresponding to the extracted data are printed.

18. The document data server according to claim 15, wherein
the document data is output to the user device, such that the page of the extracted data is displayed thereon.

19. The document data server according to claim 15, wherein
the storage unit further stores image addition management data associated with the document data, the image addition management data indicating page numbers of one or more modified pages in which a new image has been added, and
the selectable items include an item corresponding to one or more pages and indicating that the pages are modified pages.
